(19) United States
(12) Patent Application Publication
(10) Pub. No.: US 2026/0356334 A1
(43) Pub. Date: Nov. 12, 2026

(54) METHOD AND CONTROL UNIT FOR OPERATING A VEHICLE

(71) Applicant: Robert Bosch GmbH, Stuttgart (DE)

(72) Inventors: Thomas Martin Schmidt, Bietigheim-Bissingen (DE); Abel Eckart, Leingarten (DE); Christoph Diekmann, Besigheim (DE)

(21) Appl. No.: 19/119,257

(22) PCT Filed: Nov. 27, 2023
(86) PCT No.: PCT/EP2023/083158

§ 371 Date: Apr. 8, 2025

(30) Foreign Application Priority Data
Dec. 7, 2022 (DE) 10 2022 213 202.5

(51) Int. Cl. B60T 8/26; B60T 8/172

(52) U.S. Cl. CPC B60T 8/26; B60T 8/172

(57) ABSTRACT

A method for operating a vehicle. A required total braking torque at at least one wheel of the vehicle is summed using a slow-dynamic brake actuator of the vehicle and a high-dynamic control actuator of the vehicle. The brake actuator provides a slow-dynamic braking torque and the control actuator applies a control torque to the braking torque.

### FIELD

The present invention relates to a method for operating a vehicle, to a corresponding control unit, and to a corresponding computer program product.

### BACKGROUND INFORMATION

A brake control system of a vehicle may adjust a brake pressure in a wheel-specific manner with great dynamics via inlet valves, outlet valves, and at least one pump. For example, the brake pressure on a locking wheel may be briefly decreased below a brake pressure indicated by a driver of the vehicle via a brake pedal of the vehicle, in order to allow the locking wheel to rotate again. The brake pressure may subsequently be increased again by the pump until the wheel starts to lock again. In order to prevent locking over an extended period of time, the brake pressure may be repeatedly decreased and increased again.

For example, in order to generate a stabilizing yaw moment on the vehicle when the vehicle swerves, at least one wheel may be braked, independently of the driver, by applying brake pressure using the pump.

### SUMMARY

The present invention provides a method for operating a vehicle, a corresponding control unit, and a corresponding computer program product. Advantageous example embodiments, developments and improvements of the present invention emerge from the description and the rest of the disclosure herein.

In the approach presented here according to an example embodiment of the present invention, a total braking torque is generated at least one wheel of a vehicle by adding multiple partial braking torques. The partial braking torques are generated by actuators that respond or can be changed at different speeds. The actuators have different operating principles. For example, one partial braking torque may be provided by a mechanical brake, while another partial braking torque is provided by an electric drive.

In particular, the faster actuator may provide a lower share of the total braking torque than the slower actuator. In return, rapid modulations of the total braking torque can be adjusted in particular by changes in the partial braking torque of the fast actuator.

Through the approach of the present invention presented here, an inexpensive, in particular mechanical, actuator with a slower response behavior than a conventional ESP can be used for braking a vehicle since the required quick adjustments of the total braking torque are performed by an, in particular electric, actuator with a fast response behavior.

According to an example embodiment of the present invention, a method for operating a vehicle is proposed, wherein a required total braking torque at at least one wheel of the vehicle is summed using a slow-dynamic brake actuator of the vehicle and a high-dynamic control actuator of the vehicle, wherein the brake actuator provides a slow-dynamic braking torque and the control actuator applies a control torque to the braking torque.

Ideas for embodiments of the present invention may, inter alia, be regarded as being based on the concepts and findings described below.

A required total braking torque at a wheel of a vehicle may be adjusted by a driver of the vehicle via a brake pedal of the vehicle. Likewise, the total braking torque may be calculated and requested by a control unit of the vehicle.

A slow-dynamic brake actuator may be a hydraulic brake system. The slow-dynamic brake actuator may alternatively be an electromechanical brake. The slow-dynamic brake actuator may have reduced complexity in comparison to a conventional brake control system with, for example, a TCR or ESP functionality. The slow-dynamic brake actuator can adjust a braking torque in a wheel-specific manner, but a rapid change in the braking torque is not provided in this case.

A high-dynamic control actuator may be an electric drive of the wheel or of an axle of the wheel. The high-dynamic control actuator can change its control torque quickly and precisely. The high-dynamic control actuator can provide a negative or a positive control torque. The high-dynamic control actuator can thus decelerate or accelerate the wheel or the axle. The high-dynamic control actuator can provide a lower power than the slow-dynamic brake actuator.

A high-dynamic control torque can be used to apply a high-dynamic modulation of the total braking torque to the slow-dynamic braking torque. The slow-dynamic braking torque can change only slowly in comparison to the high-dynamic control torque. The high-dynamic control actuator can therefore be used in particular to drive rapid changes in the total braking torque. The slow-dynamic braking torque can slowly follow changes in the total braking torque at low gradients.

The slow-dynamic braking torque can be used to perform a slow modulation of the total braking torque.

The braking torque can be adjusted by a nominal value of the control torque to less than a maximum value of the total braking torque. A nominal value of the control torque may substantially correspond to a maximum value of the control torque. The nominal value may be slightly lower than the maximum value. By using the nominal value, a service life of the control actuator may be increased. The control actuator can be substantially utilized as intended by the reduced braking torque at any time. It is thus possible to achieve high regenerative power and to dissipate the lowest possible amount of energy as heat.

According to an example embodiment of the present invention, at the wheels of at least one axle of the vehicle, the total braking torque per wheel may be summed using a wheel-specific braking torque and an axle-specific control torque. The control actuator may act on multiple wheels simultaneously. In particular, the control actuator may act on the two wheels of one axle. The vehicle may have a control actuator on one axle and no control actuator on the other axle. The vehicle may also have one control actuator per axle. The same control torque may be applied to the wheels of the axle due to a differential gear of the axle.

A difference in the total braking torques of the wheels of the axle may be adjusted using different slow-dynamic braking torques. The difference in the total braking torque at the wheels of an axle results in a yaw moment on the vehicle. Since the vehicle has a significant mass inertia due to its mass, responses of the vehicle to the yaw moment are much slower than responses of the wheels to the acting total braking torque and a current static friction.

Alternatively, according to an example embodiment of the present invention, at the wheels of the axle, the total braking torque per wheel may be summed using the wheel-specific braking torque and a wheel-specific control torque. Each wheel of the axle may have its own control actuator.

According to an example embodiment of the present invention, the method is preferably computer-implemented and can be implemented in software or hardware, for example, or in a mixed form of software and hardware, for example in a driver assistance system.

According to an example embodiment of the present invention, the approach presented here furthermore provides a control unit in the form of a driver assistance system for a vehicle, wherein the driver assistance system is designed to carry out, control, or implement, in corresponding devices, the steps of a variant of the method presented here.

The control unit or driver assistance system may be an electrical device with at least one computing unit for processing signals or data, at least one memory unit for storing signals or data, and at least one interface and/or one communication interface for reading in or outputting data embedded in a communication protocol. The computing unit may, for example, be a signal processor, a so-called system ASIC, or a microcontroller for processing sensor signals and outputting data signals depending on the sensor signals. The memory unit may be a flash memory, an EEPROM, or a magnetic memory unit, for example. The interface may be designed as a sensor interface for reading in the sensor signals from a sensor and/or as an actuator interface for outputting the data signals and/or control signals to an actuator. The communication interface may be designed to read in or output the data wirelessly and/or by wire. The interfaces may also be software modules that are present, for example, in a microcontroller in addition to other software modules.

A computer program product or computer program comprising program code that may be stored on a machine-readable carrier or storage medium, such as a semiconductor memory, a hard disk memory, or an optical memory, and can be used to carry out, implement, and/or control the steps of the method according to one of the above-described embodiments of the present invention is advantageous as well, in particular when the program product or program is executed on a computer or a device.

It should be noted that some of the possible features and advantages of the present invention are described here with reference to different example embodiments. A person skilled in the art recognizes that the features of the control unit and the method can be suitably combined, adapted, or interchanged to arrive at further embodiments of the present invention, in view of the disclosure herein.

### BRIEF DESCRIPTION OF THE DRAWINGS

Example embodiments of the present invention are described below with reference to the figures, wherein neither the figures nor the description are to be construed as limiting the present invention.

FIG. 1 shows an illustration of a summed total braking torque according to an exemplary embodiment of the present invention.

FIG. 2 shows an illustration of an applied modulation of a summed total braking torque according to an exemplary embodiment of the present invention.

FIGS. 3A-3H show illustrations of vehicles with different brake configurations for using a method according to an exemplary embodiment of the present invention.

The figures are merely schematic and are not to scale. Identical reference signs denote identical or functionally identical features.

### DETAILED DESCRIPTION OF EXAMPLE EMBODIMENTS

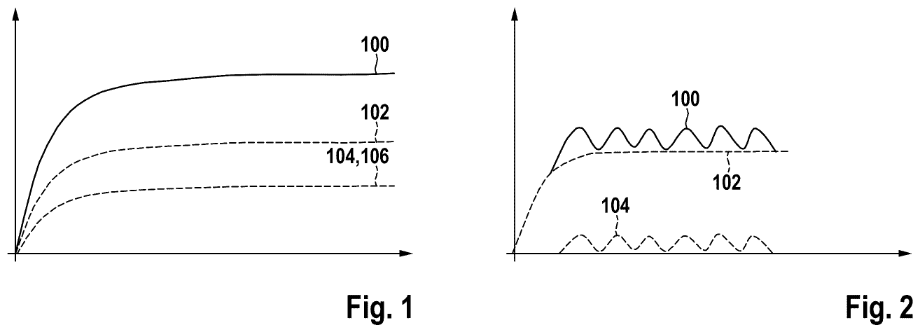

FIG. 1 shows an illustration of a total braking torque 100 at a wheel of a vehicle that is summed according to an exemplary embodiment. A diagram shows a curve of the total braking torque 100, with the time plotted on the abscissa and a torque plotted on the ordinate.

The total braking torque 100 is the sum of a braking torque 102 of a slow-dynamic brake actuator at the wheel and a control torque 104 of a high-dynamic control actuator at the wheel. Curves of the braking torque 102 and of the control torque 104 are also shown in the diagram.

The control actuator can provide a lower power than the brake actuator. A nominal value 106 of the control torque 104 is less than the total braking torque 100. If the requested total braking torque 100 is greater than the nominal value 106, the braking torque 102 of the brake actuator increases while the control torque 104 remains constant at its nominal value 106.

In an exemplary embodiment, in the case of a total braking torque 100 that is less than the nominal value 106 of the control torque 104, braking is carried out using only the control actuator. If the total braking torque 100 is greater than the nominal value 106, sufficient additional braking torque 102 is generated using the brake actuator to achieve the total braking torque 100.

In an exemplary embodiment, the braking torque 102 and the control torque 104 are increased in a specified ratio until the nominal value 106 of the control torque 104 is reached. Thereafter, only the braking torque 102 is increased.

FIG. 2 shows an illustration of an applied modulation of a summed total braking torque 100 according to an exemplary embodiment. Here, as in FIG. 1, curves of the total braking torque 100, of the braking torque 102, and of the control torque 104 are shown in a diagram. In contrast to the illustration in FIG. 1, the total braking torque 100 is not constant here due to, for example, a periodic ABS regulation. Here, a substantially constant share of the total braking torque 100 is provided by the braking torque 102. A variable share of the total braking torque 100 is provided by the variable control torque 104.

By adding the torques in this way, the high-dynamic properties of the control actuator and the slow-dynamic properties of the brake actuator are advantageously combined.

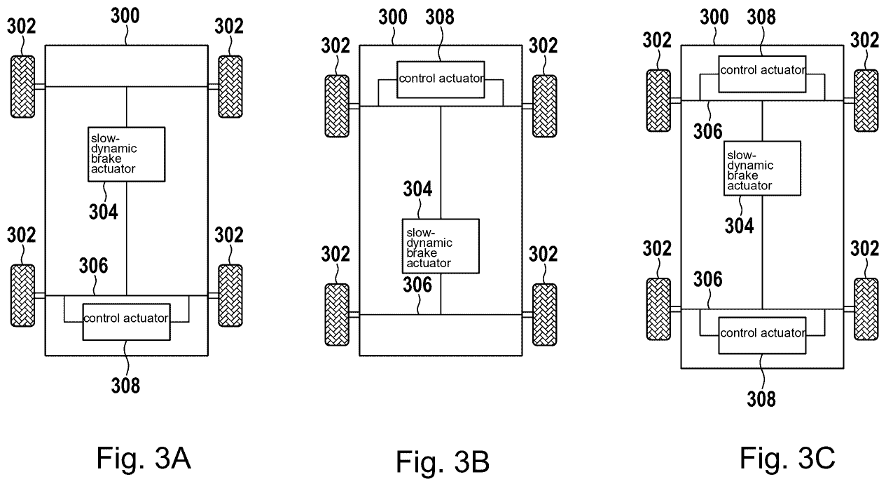

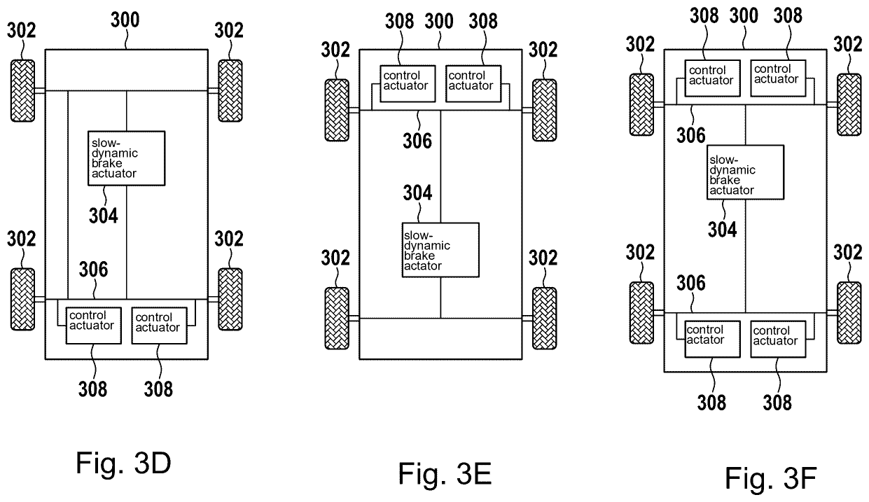

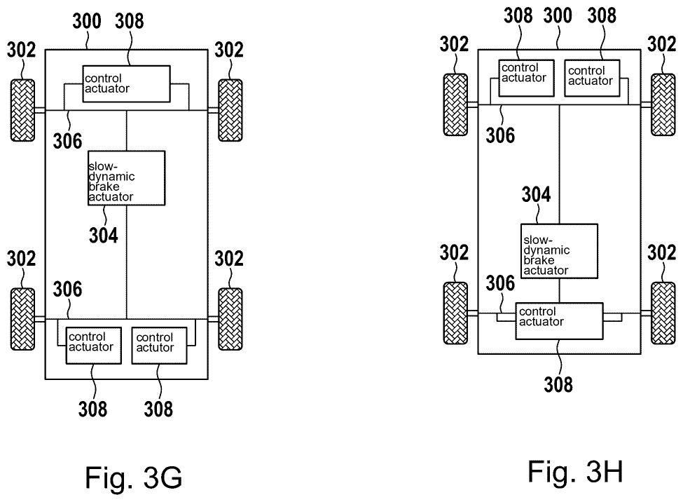

FIGS. 3A-3H shows illustrations of vehicles 300 with different brake configurations for using a method according to an exemplary embodiment.

The vehicle 300 has a slow-dynamic brake actuator 304 for each wheel 302 in all illustrations. The brake actuator 304 can provide an adjusted braking torque at each wheel 302 in a wheel-specific manner. For example, the brake actuator 304 is a hydraulic brake system of the vehicle 100.

In FIGS. 3A to 3C, in addition to the brake actuator 304, the vehicle 300 comprises a high-dynamic control actuator 308 for two wheels 302 of at least one axle 306. The control actuator 308 provides the same control torque at both wheels 302 in an axle-specific manner. The control actuator 308 is, for example, an electric drive motor of the axle 306.

In FIG. 3A, the control actuator 308 acts on the rear axle 306. In FIG. 3B, the control actuator 308 acts on the front axle 306. In FIG. 3C, one control actuator 308 each acts on the front axle 306 and on the rear axle 306.

In FIGS. 3D to 3F, the vehicle 300 has a separate control actuator 308 for each wheel 302 of at least one axle 306. The control actuators 308 can provide an adjusted control torque at each of the supplied wheels 302 in a wheel-specific manner. The control actuators 308 are, for example, single-wheel electric drives of the wheels 302.

In FIG. 3D, the control actuators 308 are arranged on the rear axle 306. In FIG. 3E, the control actuators 308 are arranged on the front axle 306. In FIG. 3F, two control actuators 308 each are arranged on the front axle 306 and on the rear axle 306.

In FIGS. 3G and 3H, the vehicle 300 in each case has one axle 306 with a control actuator 308 for providing the control torque to both wheels 302 of the axle 306, and one axle 306 with a control actuator 308 per wheel 302 of the axle 306.

In FIG. 3G, one control actuator 308 acts on both wheels 302 of the front axle 306, while two control actuators 308 act on the wheels 302 of the rear axle 306. In FIG. 3H, one control actuator 308 acts on both wheels 302 of the rear axle 306, while two control actuators 308 act on the wheels 302 of the front axle 306.

Possible embodiments of the present invention are summarized again below or presented with a slightly different choice of words.

Hybrid brake modulation by interaction of multiple individual systems is presented. The proposal relates in particular to the architecture of future brake control systems for electric or hybrid vehicles.

In addition to stabilizing properties, for example in the form of a traditional ESP/ABS, current brake control systems increasingly contain expanded function ranges, such as support of the driver, or application of force to the brake pedal during the brake actuation by an eBKV (electromechanical brake booster), or also assisted or partially assisted functions by means of a unit for active modulation of the hydraulic brake pressure (e.g., ESP, eBKV, boost unit, etc.), without active involvement of the driver. In vehicles with an electric or partially electric drive, the electric drive motors may be used for deceleration modulation. The braking power depends on the power of the electric motors.

A brake modulation function in which the capability to modulate the braking force is created by the interaction of at least two individual components is described here. Each individual component by itself may not carry out adequate brake pressure modulation for, e.g., ABS, VDC. The interaction allows conventional braking force modulation of hydraulic brake control systems such as ESP, IPB, . . . to be represented.

A modulation unit is a deceleration unit that, for example, builds up a deceleration force through wheel friction modulations, such as a hydraulic or electromechanical brake control system. The hydraulic or electromechanical brake control system is referred to as type A below.

The other modulation unit is a unit with the property of deceleration and acceleration modulations at a wheel, one axle, or both axles, or combinatorics thereof, for example a drive motor in the e-vehicle. The drive motor(s) are referred to as type B below.

Changing requirements and boundary conditions are changing the possibilities and capabilities of deceleration modulation and (wheel-specific) brake modulation in future vehicles. Increasingly, vehicles are electrified and, as a result, have the possibility of deceleration modulation by the electric motor(s). Various forms of electromechanical brake systems may also become more prevalent.

The additional systems may increase the costs and complexity in a vehicle. The approach presented here describes a functional interaction of different individual components so that they together meet the existing requirements for wheel-specific brake modulation options. This allows the individual components to be designed more cost-effectively.

In a car, it is required that the brake control system makes possible a wheel-specific active and passive brake modulation, a vehicle controller representation (ABS, VDC, TCS), an active brake modulation at the longitudinal dynamic vehicle level to represent deceleration functions in the comfort and dynamic ranges, an active brake modulation at the axle level to represent warning jerk functions as a longitudinal dynamic function, as well as a combination when braking regeneratively by means of an electric motor, in order to avoid deceleration fluctuations, due to the deceleration characteristic of an electric motor.

A functional interaction of two individual type-A and type-B systems is presented here. In interaction, the combined individual systems can improve the following properties such that an improved brake system for a vehicle results or a traditional brake control system can be designed more cost-effectively since the necessary capabilities and properties are achieved when the individual systems interact.

The presented system improves a maximum deceleration modulation capability, improves a maximum frequency of modulation changes with a particular amplitude, and consequently improves the maximum deceleration modulation capability with improved maximum frequency of the modulation changes with a particular amplitude.

The individual systems have the capability of a wheel-specific modulation capability, an axle-specific modulation capability, or a vehicle-level modulation capability.

Ideally, at least one individual system has the capability of a wheel-specific modulation capability.

The basic principle of the interaction is in the sum effectiveness of the individual components on the wheel-road-friction value combinatorics.

A type-A wheel-specific hydraulic modulation unit and at least one type-B axle-specific modulation unit can cooperate as the individual components.

In an exemplary embodiment, a type-A wheel-specific modulation unit, e.g., in the form of a hydraulic brake modulation unit of the ESP, cooperates with a type-B axle-specific modulation unit on the rear axle, e.g., an electric drive unit on the rear axle. (FIG. 3A)

In an exemplary embodiment, a type-A wheel-specific modulation unit, e.g., in the form of a hydraulic brake modulation unit of the ESP, cooperates with a type-B axle-specific modulation unit on the front axle, e.g., an electric drive unit on the front axle. (FIG. 3B)

In an exemplary embodiment, a type-A wheel-specific modulation unit, e.g., in the form of a hydraulic brake modulation unit of the ESP, cooperates with a type-B axle-specific modulation unit on the front and rear axles, e. g., an electric drive unit on the front and rear axles. (FIG. 3C)

A type-A wheel-specific hydraulic modulation unit and type-B wheel-specific modulation units can cooperate as the individual components.

In an exemplary embodiment, a type-A wheel-specific hydraulic modulation unit, e.g., in the form of a hydraulic brake modulation unit of the ESP, cooperates with type-B wheel-specific modulation units on the rear axle, e.g., electric drive units on the rear axle. (FIG. 3D)

In an exemplary embodiment, a type-A wheel-specific hydraulic modulation unit, e.g., in the form of a hydraulic brake modulation unit of the ESP, cooperates with type-B wheel-specific modulation units on the front axle, e.g., electric drive units on the front axle. (FIG. 3E)

In an exemplary embodiment, a type-A wheel-specific modulation unit, e.g., in the form of a hydraulic brake modulation unit of the ESP, cooperates with type-B wheel-specific modulation units on the front and rear axles, e. g., electric drive units on the front and rear axles. (FIG. 3F)

A type-A wheel-specific hydraulic modulation unit, type-B axle-specific modulation units, and type-B wheel-specific modulation units can cooperate as the individual components.

In an exemplary embodiment, a type-A wheel-specific modulation unit, e.g., in the form of a hydraulic brake modulation unit of the ESP, cooperates with type-B wheel-specific modulation units on the rear axle, e. g., electric drive units on the rear axle, and a type-B axle-specific modulation unit on the front axle, e.g., an electric drive unit on the front axle. (FIG. 3G)

In an exemplary embodiment, a type-A wheel-specific modulation unit, e.g., in the form of a hydraulic brake modulation unit of the ESP, cooperates with a type-B axle-specific modulation unit on the rear axle, e.g., an electric drive unit on the rear axle, and type-B wheel-specific modulation units on the front axle, e.g., electric drive units on the front axle. (FIG. 3H)

A functional design variant for the pure deceleration capability is a sum wheel modulation for achieving a desired maximum deceleration capability in the case of individual components that by themselves cannot provide the desired deceleration modulation.

The basic functional principle of the hybrid symbiogenetic approach is a sum modulation at the wheels with access to multiple type-A and type-B modulation units. For example, a type-A hydraulic modulation is carried out in combination with a type-B electric drive motor on the wheels with access to multiple modulation units so that the faster actuator regulates the target deceleration demand changes.

The target demand increase may be regulated by increasing the braking torque of the faster type-B actuator. Alternatively, the target deceleration demand decrease may be regulated by reducing the braking torque of the faster type-B actuator. Rapid reduction of the target deceleration demand may be carried out by reducing the braking torque and applying a drive power of the fast type-B actuator so that the sum torque at the wheel experiences rapid reduction. This means that the operating point of the type-A actuator may also be above the target deceleration level and may be compensated by applying an opposing torque of the type-B actuator. The dynamic requirements for the slower actuator can thus be decreased, which can result in a more cost-effective design and manufacture of the type-A actuator.

A functional design variant for wheel pressure modulation for representing an ABS functionality for the pure deceleration capability is, for example, the sum wheel modulation for achieving a desired maximum deceleration capability in the case of individual components that by themselves cannot provide the desired deceleration modulation. In this case, the type-A modulation unit applies a braking torque without dynamic (alternating) components. The type-B modulation unit is responsible for the fast dynamic components.

For example, the control strategies for typical vehicle controller interventions for an ABS functionality are that the wheel with the lower wheel-road target force on an axle is controlled by the axle-specific modulation unit (e.g., electric motor). If there is no axle-specific modulation unit on the axle, the control occurs via the hydraulic brake control system. Ideally, the frequent ABS instability modulation is taken on by the actuator system that is more performant in terms of changing the modulation. In an u-split situation, the delta value between left and right wheel is controlled by means of a type-A actuator. In this case, the build-up is basically carried out by decreasing the yaw moment so that the vehicle remains controllable.

For a VDC, TCS functionality, the type-B modulation unit is selected for longitudinal dynamic vehicle controller interventions so that the axle torques/axle slips can be adjusted more quickly. This results in better vehicle stability. The intervention by type B may be carried out by reducing the deceleration modulation by type B or by applying an acceleration by type B, depending on the topology.

Different single wheel brake interventions between left and right wheel are in principle provided in a slow-dynamic manner. The yaw inertia is much greater than the wheel inertia or axle inertia so that the type-A actuator is responsible here for adjusting the delta values between left and right wheel. In addition, attempts are made to make such interventions more slow-dynamic in order to keep the vehicle controllable.

Lastly, it should be noted that terms such as “comprising,” “including,” etc. do not exclude other elements or steps and terms such as “one” or “a” do not exclude a plurality.

1-10. (canceled)

11. A method for operating a vehicle, the method comprising the following steps:
summing a required total braking torque at at least one wheel of the vehicle using a slow-dynamic brake actuator of the vehicle and a high-dynamic control actuator of the vehicle;
providing, by the brake actuator, a slow-dynamic braking torque; and
applying, by the control actuator, a control torque to the braking torque.

12. The method according to claim 11, wherein a high-dynamic modulation of the total braking torque is applied to the slow-dynamic braking torque using a high-dynamic control torque.

13. The method according to claim 11, wherein a slow modulation of the total braking torque is performed using the slow-dynamic braking torque.

14. The method according to claim 11, wherein the slow-dynamic braking torque is adjusted by a nominal value of the control torque to less than a maximum value of the total braking torque.

15. The method according to claim 11, wherein, at wheels of at least one axle of the vehicle, a total braking torque per wheel is summed using a wheel-specific braking torque and an axle-specific control torque.

16. The method according to claim 15, wherein a difference of the total braking torques of the wheels of the axle is adjusted using different slow-dynamic braking torques.

17. The method according to claim 11, wherein the control torque can be adjusted to be negative or positive.

18. A control unit configured to operate a vehicle, the control unit configured to:
sum a required total braking torque at at least one wheel of the vehicle using a slow-dynamic brake actuator of the vehicle and a high-dynamic control actuator of the vehicle;
provide, by the brake actuator, a slow-dynamic braking torque; and
apply, by the control actuator, a control torque to the braking torque.

19. A non-transitory machine-readable storage medium on which is stored a computer program for operating a vehicle, the computer program, when executed by a processor, causing the processor to perform the following steps:
summing a required total braking torque at at least one wheel of the vehicle using a slow-dynamic brake actuator of the vehicle and a high-dynamic control actuator of the vehicle;
providing, by the brake actuator, a slow-dynamic braking torque; and
applying, by the control actuator, a control torque to the braking torque.
